(19) United States
(12) Patent Application Publication
(10) Pub. No.: US 2025/0118191 A1
(43) Pub. Date: Apr. 10, 2025

(54) HEAD-MOUNTED DISPLAY DEVICE AND METHOD FOR CONTROLLING THE SAME

(71) Applicant: SAMSUNG ELECTRONICS CO., LTD., Suwon-si (KR)

(72) Inventors: Suhyung CHA, Suwon-si (KR); Byunghwa LEE, Suwon-si (KR)

(73) Assignee: SAMSUNG ELECTRONICS CO., LTD., Suwon-si (KR)

(21) Appl. No.: 18/807,433

(22) Filed: Aug. 16, 2024

Related U.S. Application Data
(63) Continuation of application No. PCT/KR2024/011715, filed on Aug. 7, 2024.

(30) Foreign Application Priority Data
Oct. 10, 2023 (KR) 10-2023-0134375

(51) Int. Cl. G08B 21/24; G02B 27/01

(52) U.S. Cl. CPC G08B 21/24; G02B 27/017

(57) ABSTRACT

A method of requesting detachment of a head-mounted display (HMD) device, may include: detecting a sleep onset of a wearer wearing the HMD device; based on the sleep onset of the wearer being detected and the wearer not being set as a care recipient, generating an alarm for the detachment of the HMD device; and based on the sleep onset of the wearer being detected and the wearer being set as the care recipient, sending a request to detach the HMD device to an agent device not operated by the wearer.

### CROSS-REFERENCE TO RELATED APPLICATIONS

This application is a continuation application of International Application No. PCT/KR2024/011715 designating the United States, filed on Aug. 7, 2024, in the Korean Intellectual Property Receiving Office, which claims priority from Korean Patent Application No. 10-2023-0134375, filed on Oct. 10, 2023, in the Korean Intellectual Property Office, the disclosures of which are hereby incorporated by reference herein in their entireties.

### BACKGROUND

### 1. Field

The disclosure relates to a head-mounted display device and a method for controlling the same for removal.

### 2. Description of Related Art

Wearable devices that may be worn on the user's body may include head-mounted display (HMD) devices. The HMD device may be used as a display device. The HMD device is also called a face mounted display (FMD) device. The HMD device was developed for military use, but has also been commercialized for the general public based on augmented reality (AR), virtual reality (VR), or video see through (VST). For example, the HMD device is applied to a goggle-type display that may be worn on the head to be used as an interface device that allows the user to identify virtual information while performing a task or playing game while wearing the device.

When the user wearing the HMD device falls asleep against his or her will, he or she may not be able to sleep in the normal posture, which may not only cause strain to body parts, such as the head, eyes, and ears, but also interfere with a good night's sleep.

### SUMMARY

According to one or more example embodiments, a method of requesting detachment of a head-mounted display (HMD) device, may include: detecting a sleep onset of a wearer wearing the HMD device; based on the sleep onset of the wearer being detected and the wearer not being set as a care recipient, providing an alarm for the detachment of the HMD device; and based on the sleep onset of the wearer being detected and the wearer being set as the care recipient, sending a request to remove the HMD device to an agent device not operated by the wearer.

According to one or more example embodiments, a head-mounted display (HMD) device, may include: at least one sensor; a display; a communication interface configured communicate with another device; at least one processor may include processing circuitry and operably connected to the at least one sensor, the display, or the communication interface; and memory may include one or more storage media storing instructions individually or collectively executable by the at least one processor, wherein as the instructions are executed by the at least one processor, the HMD device is operated to: based on a sensing signal of the at least one sensor, detect a sleep onset of a wearer wearing the HMD device; based on the wearer not being set as a care recipient, provide an alarm for detachment of the HMD device; and based on the wearer being set as the care recipient, control the communication interface to send a request to remove the HMD device to an agent device not operated by the wearer.

According to one or more example embodiments, a head-mounted display (HMD) device, may include: a display; a communication interface; memory storing instructions; at least one processor operatively connected to the memory, the display, and the communication interface, the at least one processor being configured to execute the instructions to: detect a sleep onset of a wearer wearing the HMD device; determine that the wearer is set as a care recipient or is not set as the care recipient, based on information stored in the memory; based on the wearer not being set as the care recipient and the sleep onset being detected, provide an alarm alerting the wearer to detach the HMD device; and based on the wearer being set as the care recipient and the sleep onset being detected, control the communication interface to send a request to detach the HMD device to an agent device not operated by the wearer.

### BRIEF DESCRIPTION OF THE DRAWINGS

The above and other aspects, features, and advantages of certain embodiments of the disclosure will be more apparent from the following description taken in conjunction with the accompanying drawings, in which:

FIG. 1A shows a use example of an HMD device according to various embodiments of the disclosure;

FIG. 1B shows one or more examples of leading to detachment for each use state of an HMD device in an HMD detachment leading system according to various embodiments of the disclosure;

FIG. 2 shows a state switch of an HMD device according to various embodiments of the disclosure;

FIG. 3 is a block diagram of a configuration of an HMD device according to various embodiments of the disclosure;

FIG. 4A shows one or more arrangement examples of hardware components in an HMD device according to one or more embodiments of the disclosure;

FIG. 4B shows one or more arrangement examples of hardware components in an HMD device according to one or more embodiments of the disclosure;

FIG. 4C shows one or more arrangement examples of hardware components in an HMD device according to one or more embodiments of the disclosure;

FIG. 4D shows one or more arrangement examples of hardware components in an HMD device according to one or more embodiments of the disclosure;

FIG. 5A is a control flowchart illustrating leading to detachment in an HMD device according to one or more embodiments of the disclosure;

FIG. 5B is a control flowchart illustrating leading to detachment in an HMD device according to one or more embodiments of the disclosure;

FIG. 6A shows one or more examples of predicting a wearer's sleep onset posture in an HMD device according to one or more embodiments of the disclosure;

FIG. 6B shows one or more examples of predicting a wearer's sleep onset posture in an HMD device according to one or more embodiments of the disclosure;

FIG. 6C shows one or more examples of predicting a wearer's sleep onset posture in an HMD device according to one or more embodiments of the disclosure;

FIG. 6D shows one or more examples of predicting a wearer's sleep onset posture in an HMD device according to one or more embodiments of the disclosure;

FIG. 7 shows a wearable device to be used to detect a wearer's sleep onset in an HMD device according to one or more embodiments of the disclosure;

FIG. 8 shows one or more examples of obtaining location information about a sleeping wearer in an HMD device according to one or more embodiments of the disclosure;

FIG. 9 shows one or more examples of transferring a control right of a smart home to an agent device in an HMD detachment leading system according to one or more embodiments of the disclosure;

FIG. 10 shows one or more examples of transferring schedule management including schedules or alarms of a wearer to an agent device in an HMD detachment leading system according to one or more embodiments of the disclosure;

FIG. 11A is a control flowchart of leading to detachment in an HMD device according to one or more embodiments of the disclosure;

FIG. 11B is a control flowchart of leading to detachment in an HMD device according to one or more embodiments of the disclosure; and

FIG. 12 shows one or more examples of leading to detachment in an HMD detachment leading system according to one or more embodiments of the disclosure.

The same or similar reference denotations may be used to refer to the same or similar elements throughout the specification and the drawings.

### DETAILED DESCRIPTION

Embodiments of the disclosure are now described with reference to the accompanying drawings in such a detailed manner as to be easily practiced by one of ordinary skill in the art. However, the disclosure may be implemented in other various forms and is not limited to the embodiments set forth herein. The same or similar reference denotations may be used to refer to the same or similar elements throughout the specification and the drawings. Further, for clarity and brevity, no description is made of well-known functions and configurations in the drawings and relevant descriptions.

According to one or more embodiments of the disclosure, there may be provided an HMD device and a method for controlling the same, which detect a wearer's sleep onset for removal of the HMD device.

According to one or more embodiments of the disclosure, there may be provided an HMD device and a method for controlling the same, which detect a wearer's sleep onset to guide an agent device to request removal and/or transfer the wearer's schedules, preset alarms, or smart home control right to the agent device.

According to one or more embodiments of the disclosure, an HMD device may provide and alert to remove the HMD device when recognizing that the user is in sleep state, thereby providing a comfortable sleep environment to allow the user to maintain physical wellbeing through quality sleep.

The technical objects of the disclosure are not limited to the foregoing, and other technical objects may be derived by one of ordinary skill in the art from example embodiments of the disclosure.

Effects of the disclosure are not limited to the foregoing, and other unmentioned effects would be apparent to one of ordinary skill in the art from the following description. In other words, unintended effects in practicing embodiments of the disclosure may also be derived by one of ordinary skill in the art from example embodiments of the disclosure.

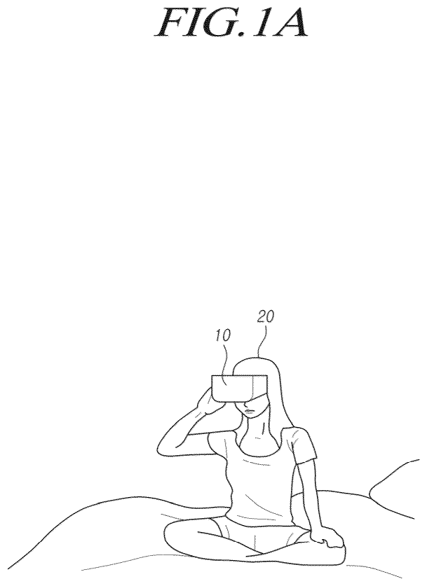

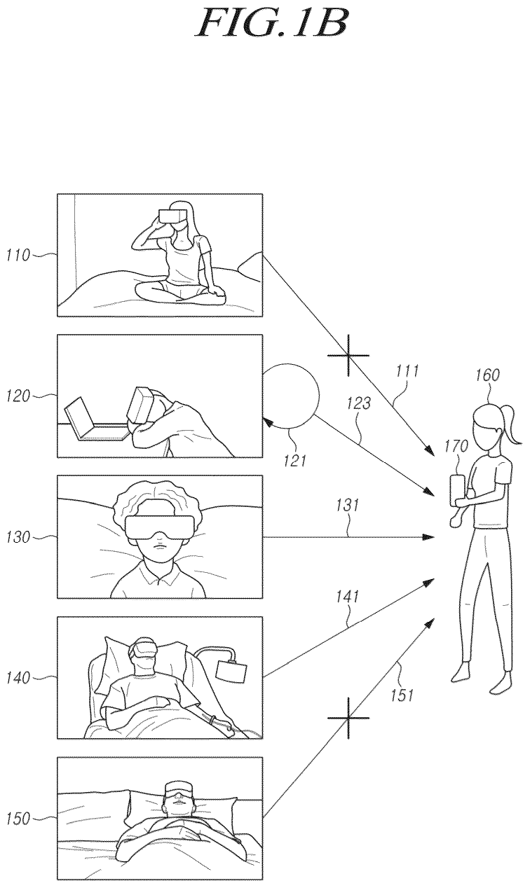

FIG. 1A is a view illustrating a use example of an HMD device according to various embodiments of the disclosure.

Referring to FIG. 1A, the HMD device 10 may be a device that the user 20 may wear on his/her head. In the disclosure, “user” or “wearer” may be interchangeably used as a term referring to a person wearing the HMD device 10. The wearer 20 may use a desired content service after wearing the HMD device 10. The content service may be, e.g., a service providing content such as a game or a movie.

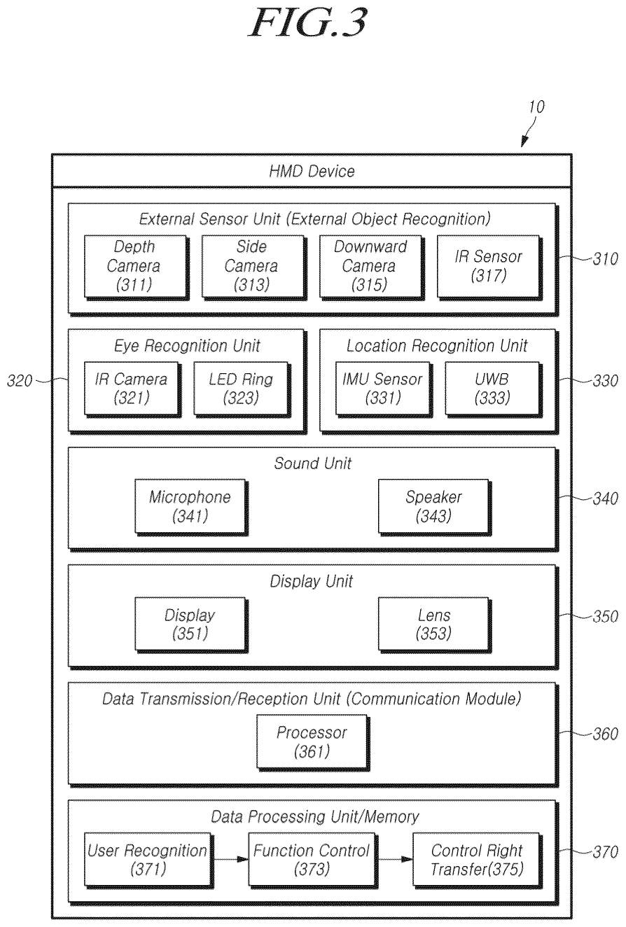

The HMD device 10 may detect the sleep onset of the wearer 20 and may request (e.g., notify) to remove the device if the posture according to the sleep onset (hereinafter, referred to as a “sleep onset posture”) is not a normal posture (e.g., position). According to one or more embodiments, the HMD device 10 may detect that the wearer 20 falls asleep in a state other than the normal posture, and may provide an alarm (e.g., notification) to remove the HMD device 10 when the wearer 20 is not set as a care recipient. In other words, an alarm leading (e.g, alerting, requesting, or notifying) the wearer 20 to detach (e.g., remove) the HMD device 10 can be provided (e.g., generated), either by the HMD device 10 itself or another device (e.g. smartphone) of the wearer. The care recipient may be, e.g., a person in need, such as a child, a patient, or an elderly person. Whether the wearer is a care recipient may be preset in the HMD device 10. According to one or more embodiments, the HMD device 10 may output a black screen through a display (e.g., the display 351 of FIG. 3) so as not to disturb the sleep of the wearer 20 when it is detected that the wearer 20 is sleeping in the normal posture. According to one or more embodiments, the HMD device 10 may request an agent device (e.g., the agent device 170 of FIG. 1B) to detach the HMD device 10 when the sleep onset of the wearer 20 is detected and the wearer 20 is set as a care recipient. In this case, the HMD device 10 may transfer its location information to the agent device 170. When the wearer 20 is set as the care recipient, the HMD device 10 may send a request to the agent device 170 to detach the HMD device 10 regardless of the sleep onset posture without generating a internal alarm. Whether or not the wearer 20 is set as a care recipient may be stored in the memory of the HMD device 10.

When the HMD device 10 calls the agent device 170 to lead to detachment, the HMD device 10 may transfer a control right for controlling the functions of an external device, such as a smart home device connected for interworking, to the agent device 170. To that end, the HMD device 10 and/or the external device may perform an authentication procedure with the device that controls the smart home.

When the HMD device 10 calls (e.g., sends a requests to) the agent device 170 to remove the HMD device 10, the HMD device 10 may transfer the authority to manage the schedule and/or preset alarm of the wearer 20 to the agent device 170. The transfer of the authority to manage the schedule and/or preset alarm may be performed under the assumption that the wearer 20 falls asleep unintentionally.

The HMD device 10 may obtain the heart rate of the wearer 20. The heart rate of the wearer 20 may be measured through a heart rate sensor. The heart rate sensor may be included in the HMD device 10. The HMD device 10 may receive the heart rate of the wearer 20 from a wearable device such as a smart watch. The HMD device 10 may determine the sleep quality of the wearer 20 based on the heart rate of the wearer 20. For example, when it is detected that the heart rate of the wearer 20 is faster than or equal to a threshold level, the HMD device 10 may determine that the sleep quality of the wearer 20 is poor. In this case, the HMD device 10 may notify the agent device 170 that the wearer 20 is not sleeping comfortably.

In the HMD device 10, a plurality of agent devices 170 may be configured or set up to remove the HMD device 10, transfer the control right of the external device, transfer the authority for managing the schedule and/or the preset alarm, or indicate that the wearer 20 has poor sleep quality. In this case, priority may be assigned to the plurality of agent devices 170. The HMD device 10 may call the agent device 170 based on the priority. For example, when an event for calling occurs, the HMD device 10 may call an agent device having the highest priority. When the cause of the call is not resolved until a predetermined time elapses after the call, the HMD device 10 may call an agent device having a next priority.

FIG. 1B is a view illustrating one or more examples of leading to detachment for each use state of an HMD device (e.g., the HMD device 10 of FIG. 1A) in an HMD removal system according to various embodiments of the disclosure.

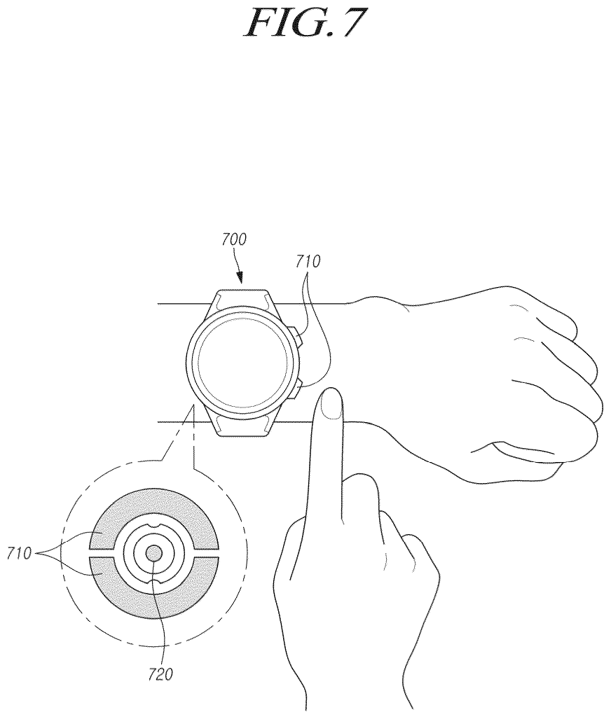

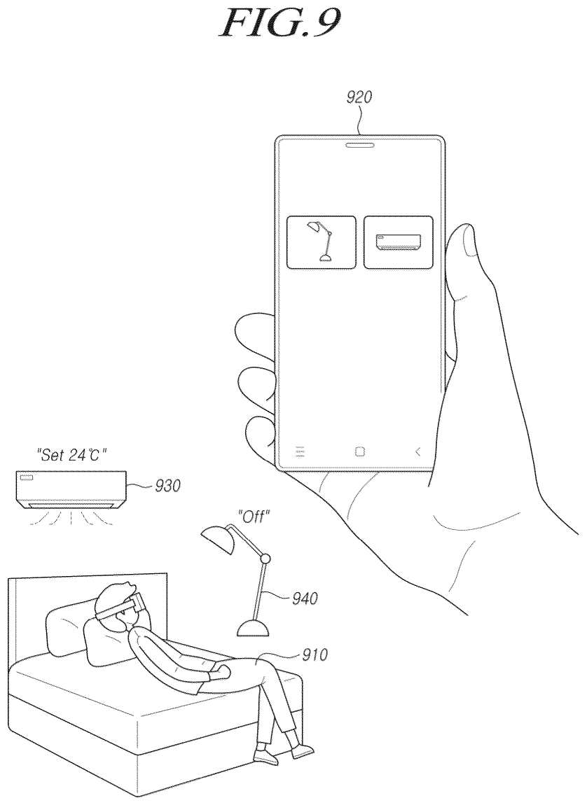

Referring to FIG. 1B, in the HMD leading to detachment system, the HMD device 10 may perform leading (e.g., requesting, alerting or notifying) to detachment (e.g., removal) of the HMD device considering the state of the wearer (e.g., the wearer 20 of FIG. 1A). The HMD detachment leading system may include an HMD device 10, an agent device 170, an external device (e.g., the air conditioner 930 or the lighting device 940 of FIG. 9) such as a smart home device, or a wearable device such as a smart watch (e.g., the smart watch 700 of FIG. 7).

The state of the wearer 20 may include a use state 110 or a sleep state 120, 130, 140, and 150. The use state 110 may be a state in which the wearer 20 is normally using a desired content service through the HMD device 10, such as watching a movie. The sleep state 120, 130, 140, and 150 may be a state in which the wearer 20 is asleep while wearing the HMD device 10. The sleep state 120, 130, 140, and 150 may be divided into a first sleep state 120 in which the wearer falls asleep unwilfully/unintentionally or a second sleep state 130, 140, and 150 in which the wearer falls asleep willfully/intentionally. The HMD device may analyze the sleep onset posture of the wearer 20 to determine whether the wearer 20 is in the first sleep state 120 or the second sleep state 130, 140, or 150. For example, when the sleep onset posture is not the normal posture, the HMD device 10 may determine that the wearer is in the first sleep state 120. For example, when the sleep onset posture is the normal posture, the HMD device 10 may determine that the wearer is in the second sleep state 130, 140, and 150. The second sleep state 130, 140, and 150 may be divided considering whether the wearer 20 is a care recipient. The care recipient may be, e.g., a person in need, such as a child, a patient, or an elderly person.

When the wearer 20 is in the use state 110, the HMD device 10 may not generate (e.g., provide) a self-detachment leading sound (e.g., sound notification to remove the HMD device 10) or may not provide an operation for leading to detachment, such as notifying the agent 160 (reference numeral 111).

When the wearer 20 is in the first sleep state 120 in the sleep time range (e.g., after 8 p.m.), the HMD device 10 may generate a self-detachment leading sound (reference numeral 121). The HMD device 10 may request the agent device 170 to detach the HMD device 10 when not detached even though the self-detachment leading sound is generated for a predetermined time (e.g., 10 minutes) (reference numeral 123). When the wearer 20 is in the first sleep state 120 in an activity time range other than the sleep time range (e.g., after 8 p.m.), the HMD device 10 may wait for a predetermined time (e.g., 30 minutes) for allowing a nap, and then may generate a self-detachment leading sound.

When the wearer 20, who is a care recipient, is in the second sleep state 130 and 140, the HMD device 10 may request the agent device 170 to detach the HMD device 10 without generating a self-detachment leading sound (reference numbers 131 and 141).

When the wearer 20, who is not the care recipient, is in the second sleep state 150, the HMD device 10 may not generate a self-detachment leading sound or may not provide an operation for leading to detachment such as notifying the agent 160 (reference numeral 151). The HMD device 10 may output a black screen through the display so as not to disturb the sleep of the wearer 20.

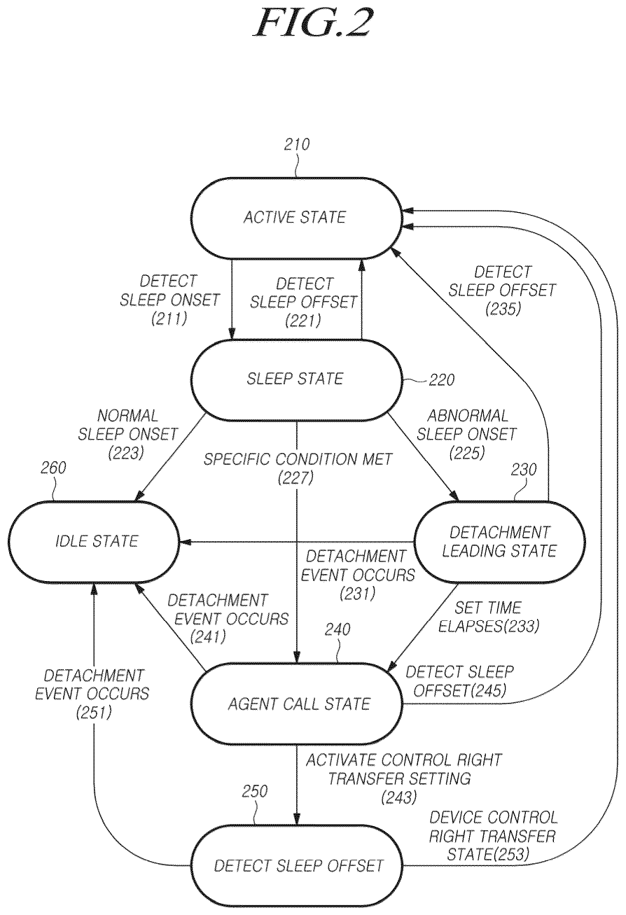

FIG. 2 is a view illustrating a state switch of an HMD device (e.g., the HMD device 10 of FIG. 1A) according to various embodiments of the disclosure.

Referring to FIG. 2, the HMD device 10 may have a plurality of operation states. According to one or more embodiments, the HMD device 10 may include an active state 210, a sleep onset (or hypnagogic) state 220, a detachment leading state 230, an agent call state 240, a device control right transfer state 250, or an idle state 260. The HMD device 10 may further include another operation state not shown according to a supported function or operation.

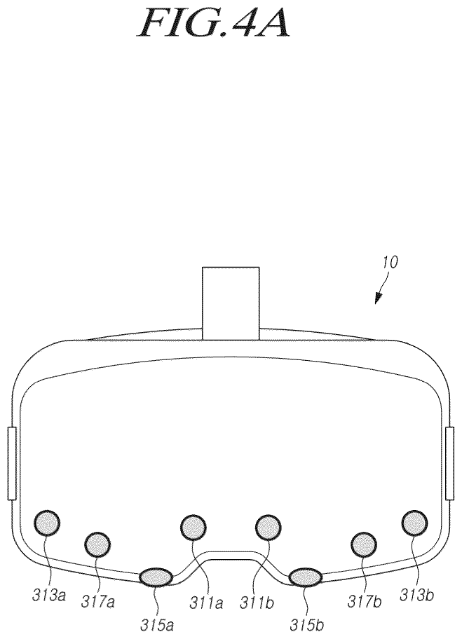

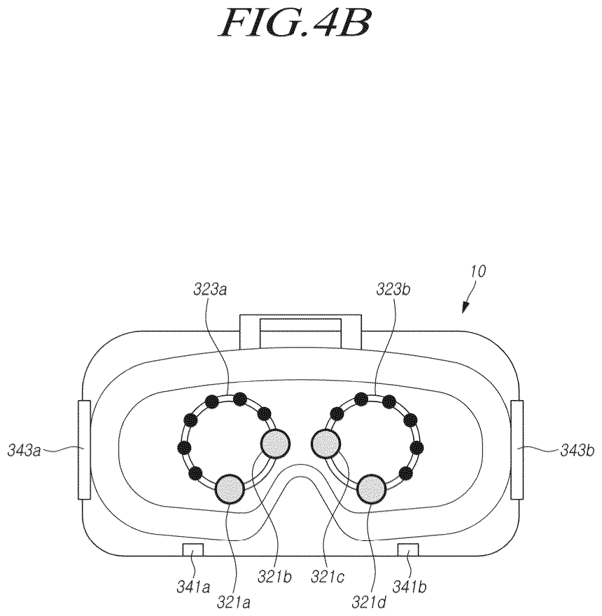

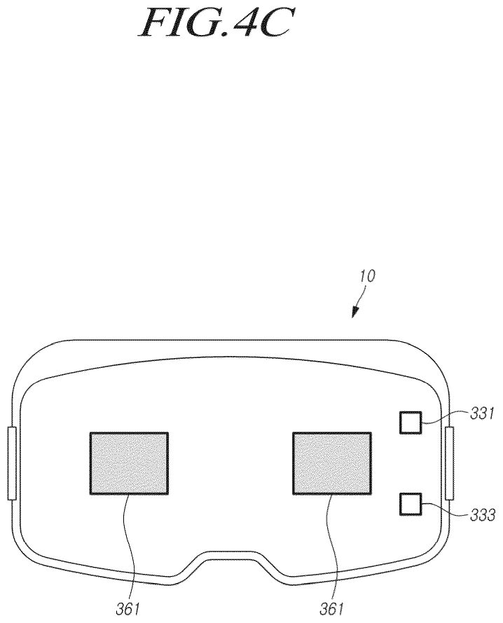

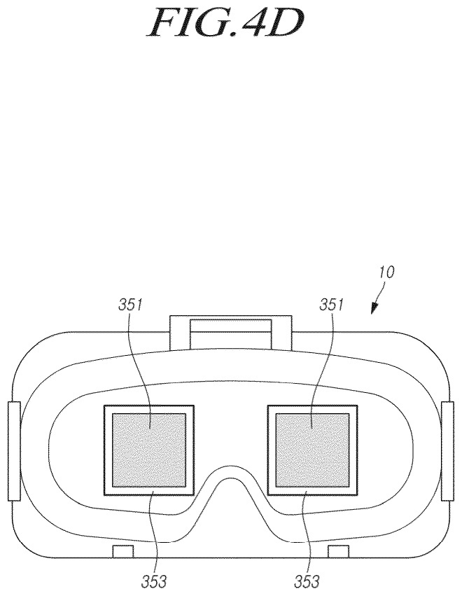

The HMD device 10 may operate in the active state 210 when a wearer (e.g., the wearer 20 of FIG. 1A) is using a predetermined content service. In the active state 210, the HMD device 10 may determine whether the wearer 20 falls asleep based on information obtained from at least one sensor (e.g., a capacitive sensor) or at least one camera (e.g., the first to fourth IR cameras 321a, 321b, 321c, and 321d of FIG. 4B). The HMD device 10 may determine whether the wearer 20 falls asleep based on biometric information transferred by a wearable device smart watch (e.g., the smart watch 700 of FIG. 7) worn by the same person or an indicator indicating the sleep onset.

When the HMD device 10 detects the sleep onset of the wearer 20, the HMD device 10 may determine whether the wearer 20 falls asleep in a normal situation. For example, the HMD device 10 may identify the sleep onset posture of the wearer 20. When the HMD device 10 identifies that the wearer's sleep onset posture is a normal posture, the HMD device 10 may determine that the wearer falls asleep in the normal situation. For example, the HMD device 10 may identify location information. When the HMD device 10 identifies that the location where the wearer 20 is asleep is a location where a normal sleep onset is possible (e.g., a bedroom, a sofa, or the like), the HMD device 10 may determine that the wearer 20 falls asleep in the normal situation. For example, the HMD device 10 may identify the position or movement of the eyes or a gazing direction of the wearer 20. The HMD device 10 may determine whether the wearer 20 falls asleep in the normal situation based on an eye position of the wearer 20 and an alignment state between a lens (e.g., the lens 353 of FIG. 4D) or a display (e.g., the display 351 of FIG. 4D). When it is determined that the wearer 20 falls asleep in the normal situation, the HMD device 10 may switch the status to the idle state 260 (operation 223). When it is determined that the wearer 20 falls asleep in an abnormal situation, the HMD device 10 may switch the state to the detachment leading state 230 (operation 225).

When the HMD device 10 detects the sleep onset of the wearer 20, the HMD device 10 may determine whether a specific condition is met. The specific condition may be, e.g., whether the wearer 20 is set as a care recipient. The care recipient may be, e.g., a person in need, such as a child, a patient, or an elderly person. When it is determined that the specific condition is met, the HMD device 10 may switch the state to the agent call state 240.

In the detachment leading state 230, the HMD device 10 may generate (e.g., provide) a detachment leading sound (e.g., sound notification for removal) for leading to detachment of the HMD device 10 worn by the wearer 20. The detachment leading sound may be output through a speaker (e.g., the speaker 343 of FIG. 3) included in the HMD device 10. The detachment leading sound may be output through an earphone worn by the wearer 20. The detachment leading sound may be preset. The detachment leading sound may be updated.

The HMD device 10 may monitor whether a detachment event occurs in the detachment leading state 230. The detachment event may occur when the HMD device 10 is detached from the wearer 20. When the detachment event occurs, the HMD device 10 may switch to the idle state 260 (operation 231).

The HMD device 10 may monitor whether a detachment event does not occur in the detachment leading state 230 and a set time (e.g., 10 minutes) elapses. When the set time elapses, the HMD device 10 may switch to the agent call state 240 (operation 233). The waiting for the set time is to provide a time for the wearer 20 to hear a detachment leading sound and to detach the HMD device 10 by herself.

The HMD device 10 may determine whether there is an abnormality in the heart rate of the wearer 20 in the detachment leading state 230. For example, the HMD device 10 may determine the sleep quality of the wearer 20 based on the heart rate of the wearer 20. When it is detected that the heart rate of the wearer 20 is faster than or equal to a threshold level, the HMD device 10 may determine that the sleep quality of the wearer 20 is poor. In this case, the HMD device 10 may switch the state to the agent call state 240.

The HMD device 10 may determine whether the agent call function is activated in the agent call state 240. The agent call function may be activated by setting information about an agent to request for assistance with detachment (e.g., removal) of the HMD device 10 . . . . The agent information may be information (e.g., a phone number) necessary to transfer information to lead to detachment.

When the agent call function is activated in the agent call state 240, the HMD device 10 may transmit a message for leading to detachment to an agent device (e.g., the agent device 170 of FIG. 1B). When the HMD device 10 calls the agent 160, the HMD device 10 may transfer location information about the HMD device 10 to the agent device 170. The location information allows the agent 160 to quickly identify the sleep onset location of the wearer 20 through the agent device 170. The HMD device 10 may determine whether the agent device 170 approaches within a predetermined range. The HMD device 10 may generate a detachment leading sound when the agent device 170 approaches. The generation of the detachment leading sound may serve to lead to the agent 160 to more easily approach the location of the HMD device 10.

The HMD device 10 may monitor whether a detachment event occurs in the agent call state 240. The detachment event may occur when the HMD device 10 is detached from the wearer 20 by the agent 160. When the detachment event occurs, the HMD device 10 may switch to the idle state 260 (operation 241).

The HMD device 10 may determine whether the control right transfer setting is activated in the agent call state 240. When the control right transfer setting is activated, the HMD device 10 may switch to the device control right transfer state 250 (operation 243).

In the device control right transfer state 250, the HMD device 10 may assign (or transfer) a control right capable of controlling a function of an external device such as a smart home device connected for interworking to the agent device 170. To that end, the HMD device 10 and/or the external device may perform an authentication procedure with the device that controls the smart home.

In the HMD device 10, a plurality of agent devices 170 to lead to detachment, to transfer the control right of the external device, to transfer the authority for managing the schedule and/or the preset alarm, or to indicate that the wearer 20 has poor sleep quality in the agent call state 240 may be set. In this case, priority may be assigned to the plurality of agent devices 170. The HMD device 10 may call the agent device 170 based on the priority. For example, when an event for calling occurs, the HMD device 10 may call an agent device having the highest priority. When the cause (e.g., detachment of the HMD device 10) of the call is not resolved until a predetermined time elapses after the call, the HMD device 10 may call an agent device having a next priority.

In the device control right transfer state 250, the HMD device 10 may transfer the authority to manage the schedule and/or preset alarm of the wearer 20 to the agent device 170. The transfer of the authority to manage the schedule and/or preset alarm may be performed under the assumption that the wearer 20 falls asleep unintentionally.

The HMD device 10 may monitor whether a detachment event occurs in the device control right transfer state 250. The detachment event may occur when the HMD device 10 is detached by the agent 160 or the wearer 20. When the detachment event occurs, the HMD device 10 may switch to the idle state 260 (operation 251).

In the idle state 260, the HMD device 10 may output a black screen through the display 351 and may block audio output.

The HMD device 10 may monitor whether a sleep offset (or hypnopompic) state of the wearer 20 occurs in any one of the sleep state 220, the detachment leading state 230, the agent call state 240, or the device control right transfer state 250. When the HMD device 10 detects the occurrence of the hypnopompic state, the HMD device 10 may switch to the active state 210 (operations 221, 235, 245, and 253).

FIG. 3 is a block diagram illustrating an HMD device (e.g., the HMD device 10 of FIG. 1A) according to various embodiments of the disclosure.

Referring to FIG. 3, the HMD device 10 may include an external sensor unit 310, an eye recognition unit 320, a location recognition unit 330, a sound unit 340, a display 350, a data transmission/reception unit (communication module) 360, or a data processing unit/memory 370. The external sensor unit 310 may include a depth camera 311, a side camera 313, a downward camera 315, or an infrared ray (IR) sensor 317. The eye recognition unit 320 may include an IR camera 321 or an LED ring 323. The location recognition unit 330 may include an inertial measurement unit (IMU) sensor 331 or an ultra-wideband (UWB) 333. The sound unit 340 may include a microphone 341 or a speaker 343. The display unit 350 may include a display 351 or a lens 353. The data transmission/reception unit (e.g., a communication module including a communication circuit) 360 may include at least one processor 361 (including, e.g., a processing circuit). The data processing unit/memory 370 may include a user recognition module 371, a function control module 373, or a control right transfer module 375.

The external sensor unit 310 may include at least one sensor. The external sensor unit 310 may output a sensing (e.g., detection) signal for recognizing an external object. The external sensor unit 310 may detect an operation state (e.g., power or temperature) of the HMD device 10, an external environment state (e.g., a user state), or a movement of a hand or gaze for interaction with the user, and may generate an electrical signal or a data value corresponding to the detected state. The external sensor unit 310 may further include a gesture sensor, a gyro sensor, an atmospheric pressure sensor, a magnetic sensor, an acceleration sensor, a grip sensor, a proximity sensor, a color sensor, a biometric sensor, a temperature sensor, a humidity sensor, or an illuminance sensor in addition to the depth camera 311, the side camera 313, the downward camera 315, or the IR sensor 317. The depth camera 311 may output a sensing signal corresponding to a distance to an object. The side camera 313 may output an image obtained by photographing outward of the side surface of the HMD device 10. The downward camera 315 may output an image obtained by photographing downward of the HMD device 10. The IR sensor 317 may output a sensing signal capable of recognizing whether an object is present.

The eye recognition unit 320 may include an IR camera 321 or an LED ring 323 disposed toward the wearer 20. The IR camera 321 may output an image of the eyes of the wearer 20 and the surroundings of the eyes. The LED ring 323 may output a sensing signal for checking the eye alignment state of the wearer 20.

The location recognition unit 330 may include an IMU sensor 331 or a UWB 333 for obtaining location information about the HMD device 10. The IMU sensor 331 may obtain location information about the HMD device 10 on three-dimensional coordinate axes. The IMU sensor 331 may output the obtained location information as a sensing signal. The UWB 333 may obtain location information about the HMD device 10 based on ultra-wideband technology. The UWB 333 may output a sensing signal corresponding to the obtained location information.

The sound unit 340 may include a microphone 341 for converting external audio into an electrical signal or a speaker 343 for converting an electrical signal into an audible audio signal. The speaker 343 may generate a detachment leading sound (e.g., sound notification for removal) under the control of the processor 361.

The display 350 may include a display 351 to output visual information (e.g., real image information or virtual image information) to the outside (e.g., a wearer (e.g., the wearer 20 of FIG. 1A)). The display 350 may include, e.g., a display, a hologram device, or a projector and a control circuit to control a corresponding device. The display unit 350 may be controlled by electrical connection with the processor 361. The display unit 350 may include a lens 353. The lens 353 may be provided on an inner side (e.g., surface) of the HMD device 10.

The processor 361 may execute software to control at least one other component (e.g., a hardware or software component) such as the external sensor unit 310, the eye recognition unit 320, the location recognition unit 330, the sound unit 340, or the display unit 350 electrically connected thereto, and may perform various data processing or computations. As at least part of data processing or computations, the processor 361 may store commands or data received from another component (e.g., the external sensor unit 310, the eye recognition unit 320, the location recognition unit 330, the sound unit 340, or the display unit 350) in the data processing unit/memory 370 (e.g., volatile memory), or may process the commands or data stored in the data processing unit/memory 370 and store the processed result data in the data processing unit/memory 370.

The data transmission/reception unit 360 may include a communication module. The communication module may support establishing a direct (e.g., wired) communication channel or a wireless communication channel with another device (e.g., an agent device (e.g., the agent device 170, the wearable device, or the smartphone of FIG. 1B)) and performing communication via the established communication channel. The communication module may include one or more communication processors that operate independently of the processor 361 and support direct (e.g., wired) communication or wireless communication. The communication module may include, e.g., a wireless communication module (e.g., a cellular communication module, a short-range wireless communication module, or a global navigation satellite system (GNSS) communication module) or a wired communication module (e.g., a local area network (LAN) communication module or a power line communication module). A corresponding one of these communication modules may communicate with the external device via a network (e.g., a short-range communication network, such as Bluetooth™, wireless-fidelity (Wi-Fi) direct, or infrared data association (IrDA) or a long-range communication network, such as a legacy cellular network, a 5G network, a next-generation communication network, the Internet, or a computer network (e.g., local area network (LAN) or wide area network (WAN)). These various types of communication modules may be implemented as a single component (e.g., a single chip), or may be implemented as multi components (e.g., multi chips) separate from each other.

The data processing unit/memory 370 may store various data used by at least one component (e.g., the external sensor unit 310, the eye recognition unit 320, the location recognition unit 330, the sound unit 340, or the display unit 350). The data may include, e.g., software and input data or output data for a command related thereto. The data processing unit/memory 370 may include, e.g., a volatile memory or a non-volatile memory.

The data processing unit/memory 370 may include a user recognition module 371 for monitoring the state of the user, such as the sleep onset of the wearer 20. The data processing unit/memory 370 may include a function control module 373 for controlling a function provided by the HMD device 10. The data processing unit/memory 370 may include a control right transfer module 375 that performs a function of transferring a control right to control an external device remotely controllable by the HMD device 10 or another device (e.g., a smart phone) of the wearer 20 to the agent device 170. The control right transfer module 375 may transfer control right for the schedule and/or preset alarm managed by the HMD device 10 or another device (e.g., a smart phone) of the wearer 20 to the agent device 170.

According to one or more embodiments, the processor 361 may detect the sleep onset of the wearer 20 and may provide an operation of leading to detachment when the sleep onset posture is not a normal posture. The processor 361 may detect that the wearer 20 falls asleep in a state other than the normal posture, and may control the speaker 343 to generate an alarm for leading to detachment of the HMD device 10 when the wearer 20 is not set as a care recipient. The care recipient may be, e.g., a person in need, such as a child, a patient, or an elderly person. Whether the wearer is a care recipient may be preset in the HMD device 10. When the processor 361 detects that the wearer 20 falls asleep in the normal posture, the processor 361 may output a black screen through the display 351 so as not to disturb the sleep of the wearer 20.

When the sleep onset of the wearer 20 is detected and the wearer 20 is set as a care recipient, the processor 361 may request the agent device 170 to detach the HMD device 10. The processor 361 may transfer its location information to the agent device 170. When the wearer 20 is set as a care recipient, the processor 361 may not generate a self-alarm and may request the agent device 170 to detach the HMD device 10 through the communication module regardless of the sleep onset posture.

When the processor 361 calls the agent device 170 to lead to detachment, the processor 361 may transfer a control right for controlling a function of an external device, such as a smart home device connected for interworking, to the agent device 170. To that end, the processor 361 may perform an authentication procedure with the device that controls the smart home.

When the processor 361 calls the agent device 170 to lead to detachment, the processor 361 may transfer the authority to manage the schedule and/or preset alarm of the wearer 20 to the agent device 170. The transfer of the authority to manage the schedule and/or preset alarm may be performed under the assumption that the wearer 20 falls asleep unintentionally.

The processor 361 may obtain the heart rate of the wearer 20. The heart rate of the wearer 20 may be measured through a heart rate sensor. The heart rate sensor may be included in the HMD device 10. The processor 361 may receive the heart rate of the wearer 20 from a wearable device such as a smart watch through a communication module. The processor 361 may determine the sleep quality of the wearer 20 based on the heart rate of the wearer 20. For example, when it is detected that the heart rate of the wearer 20 is faster than or equal to a threshold level, the processor 361 may determine that the sleep quality of the wearer 20 is poor. In this case, the processor 361 may notify the agent device 170 through the communication module that the wearer 20 is not getting quality sleep.

In the HMD device 10, a plurality of agent devices 170 to lead to detachment, to transfer the control right of the external device, to transfer the authority for managing the schedule and/or the preset alarm, or to indicate that the wearer 20 has poor sleep quality may be set. In this case, priority may be assigned to the plurality of agent devices 170. The processor 361 may call the agent device 170 based on the priority. For example, when an event for calling occurs, the processor 361 may call an agent device having the highest priority. When the cause of the call is not resolved until a predetermined time elapses after the call, the processor 361 may call an agent device having a next priority.

FIGS. 4A, 4B, 4C, and 4D are views illustrating an arrangement example of hardware components in an HMD device (e.g., the HMD device 10 of FIG. 1A) according to various embodiments of the disclosure.

Referring to FIGS. 4A to 4D, the HMD device 10 may include a front portion exposed to the outside or an inner side (e.g., surface) facing a wearer (e.g., the wearer 20 of FIG. 1A). An external sensor unit (e.g., the external sensor unit 310 of FIG. 3) including left/right depth cameras 311a and 311b, left/right side cameras 313a and 313b, left/right downward cameras 315a and 315b, or left/right IR sensors 317a and 317b may be configured in the front portion of the HMD device 10 (see FIG. 4A). The locations where the left/right depth cameras 311a and 311b, the left/right side cameras 313a and 313b, the left/right downward cameras 315a and 315b, or the left/right IR sensors 317a and 317b are disposed in the front portion are not necessarily fixed, but may be determined at the design stage of the HMD device 10.

An eye recognition unit (e.g., the eye recognition unit 320 of FIG. 3) including the IR camera 321 or the LED ring 323 may be configured on the inner side (e.g., surface) of the HMD device 10. A sound unit (e.g., the sound unit 340 of FIG. 3) including the microphone 341 or the speaker 343 may be configured on the inner surface of the HMD device 10 (see FIG. 4B).

The HMD device 10 may include at least one processor 361. The HMD device 10 may include a location recognition unit (e.g., the location recognition unit 330 of FIG. 3) including the IMU sensor 331 or the UWB 333 (see FIG. 4C).

The display unit 350 including the display 351 or the lens 353 may be configured on the inner side (e.g., surface) of the HMD device 10 (see FIG. 4D).

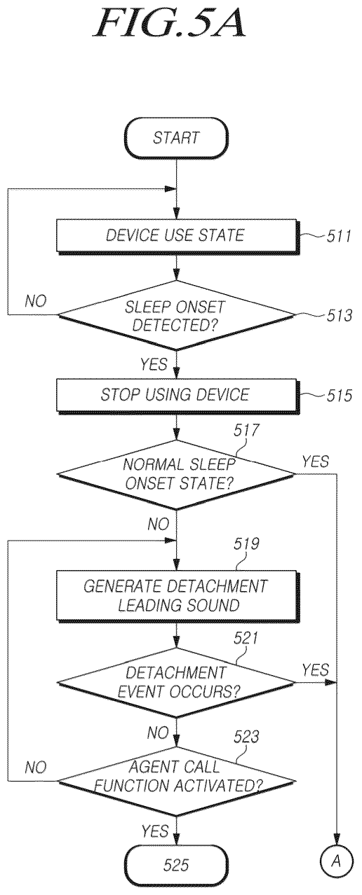

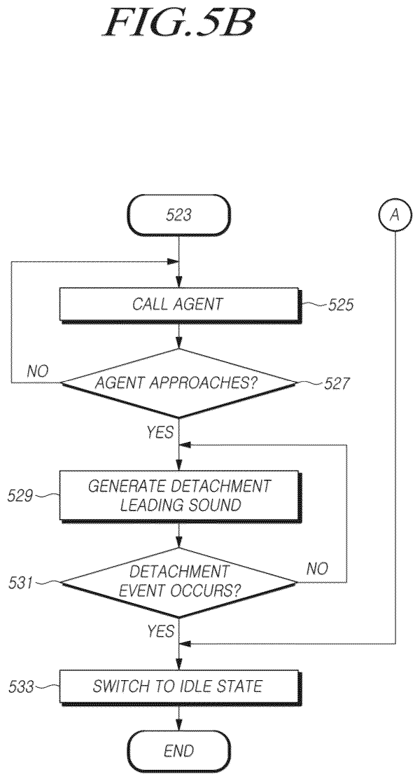

FIGS. 5A and 5B are control flowcharts illustrating leading to detachment in an HMD device (e.g., the HMD device 10 of FIG. 1A) according to one or more embodiments of the disclosure.

Referring to FIG. 5A or 5B, in operation 511, the HMD device 10 may operate in an active state (e.g., the active state 210 of FIG. 2). The active state 210 may be a state in which the device is normally used. For example, in the active state 210, the HMD device 10 may be worn by the user (e.g., the wearer 20 of FIG. 1A). The wearer 20 may access (e.g., use) desired content through the HMD device 10 that is being worn.

In operation 513, the HMD device 10 may detect the sleep onset of the wearer 20. When the HMD device 10 detects that the wearer 20's eyes are closed for a predetermined time (e.g., 10 minutes), the HMD device 10 may determine that the wearer 20 is in the sleep onset state. The HMD device 10 may detect the sleep onset state of the wearer 20 using information obtained by at least one sensor (e.g., a capacitive sensor) or at least one camera (e.g., the first to fourth IR cameras 321a, 321b, 321c, and 321d of FIG. 4B). The HMD device 10 may be detected by the biometric information transferred by the wearable device worn by the same person or an indicator indicating the sleep onset. The wearable device may be a smart watch (e.g., the smart watch 700 of FIG. 7) that provides a sleep measurement function.

When the HMD device 10 detects the sleep onset of the wearer 20, in operation 515, the HMD device 10 may switch to a sleep onset state (e.g., the sleep onset state 220 of FIG. 2). In the sleep onset state 220, the HMD device 10 may stop the content service being used.

In operation 517, the HMD device 10 may determine whether the wearer 20 falls asleep in the normal hypnagogic state.

According to one or more embodiments, the HMD device 10 may analyze the sleep onset posture of the wearer 20 and may determine whether the sleep onset posture of the wearer 20 is a normal posture according to the analysis. The normal posture may be a posture in which it is easy to predict that the wearer's sleep onset is an sleep onset by the will of the wearer 20. The normal posture may be, e.g., a lying posture. The normal posture may be, e.g., a posture of lying down on a bed. The normal posture may be, e.g., a posture lying on a sofa. The normal posture may be a posture of the wearer 20 in which the HMD device 10 is not in contact with a surrounding object. The normal posture may be a state in which the wearer 20 is wearing the HMD device 10 so that the eyes of the wearer 20 match the location or direction of a lens (e.g., the lens 353 of FIG. 4D) provided inside the HMD device 10 within an error range. The normal posture may be a state in which the wearer 20 lies horizontally on the bed. The HMD device 10 may determine the posture in which the wearer 20 is lying down by location information obtained based on UWB technology and/or a sensing signal sensed by at least one sensor (e.g., the downward cameras 315a and 315b of FIG. 4A or the IMU sensor 331 of FIG. 4C). The posture information about the wearer 20 predicted (e.g., estimated or determined) by the sensing signal may be information indicating which direction and/or which posture the wearer 20 is sleeping in. The normal posture may be in a state in which it is not recognized that the wearer 20 is tossed and turned. The tossing and turning of the wearer 20 may be detected by a wearable device such as the smart watch 700 worn by the wearer 20.

The HMD device 10 may determine whether the sleep onset posture of the wearer 20 is the normal posture based on an image captured by at least one camera or a sensing signal sensed by at least one sensor (e.g., the first and/or second IR sensors 317a and 317b of FIG. 4A). The at least one camera may include at least one depth camera (e.g., the first and second depth cameras 311a and 311b of FIG. 4A). The at least one camera may include at least one side camera (e.g., the first and second side cameras 313a and 313b of FIG. 4A). The at least one camera may include the at least one depth camera 311a or 311b or the at least one side camera 313a or 313b. The at least one camera may include the at least one depth camera 311a and 311b and the at least one side camera 313a and 313b.

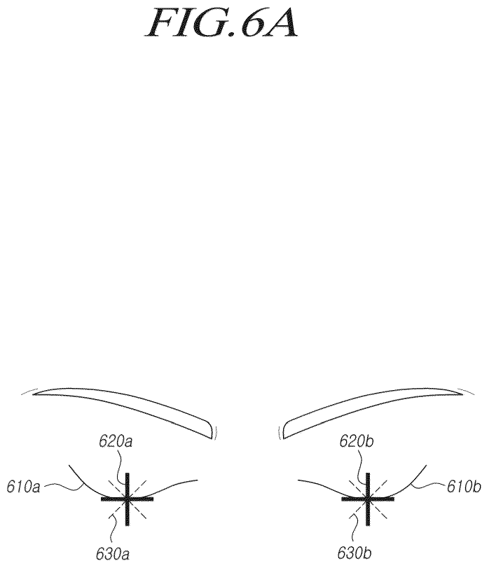

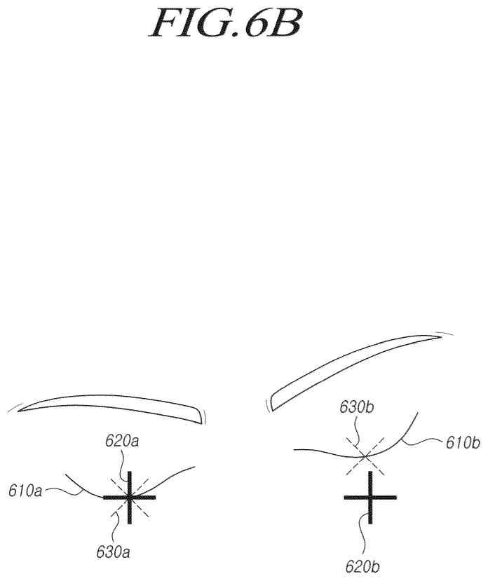

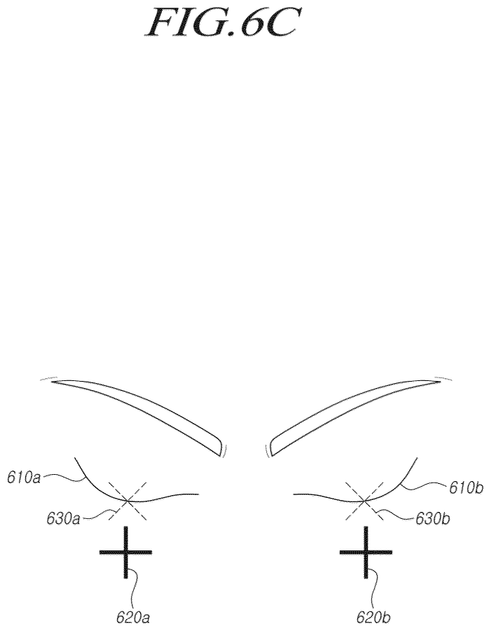

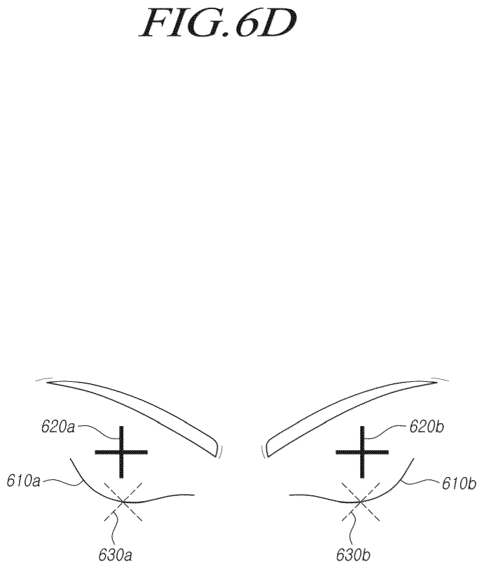

The HMD device 10 may determine whether the sleep onset posture of the wearer 20 is the normal posture based on the position of the wearer 20's eyes and the location of a lens (e.g., the lens 353 of FIG. 4D) or a display (e.g., the display 351 of FIG. 4D). The HMD device 10 may determine whether the sleep onset posture of the wearer 20 is the normal posture based on the direction when the wearer 20's eyes are viewed from a lens (e.g., the lens 353 of FIG. 4D) or a display (e.g., the display 351 of FIG. 4D). In this case, the HMD device 10 may determine that the sleep onset posture of the wearer 20 is not the normal posture by recognizing that the direction of at least one of the left eye or the right eye is turned (see FIGS. 6A to 6D).

When it is determined that the wearer 20 is asleep in the normal posture, the HMD device 10 may switch the state to the idle state (the idle state 260 of FIG. 2) to output a black screen through a display (e.g., the display 351 of FIG. 3) and block audio output in operation 533.

When it is determined that the sleep onset posture of the wearer 20 is not the normal posture, in operation 519, the HMD device 10 may switch to the detachment leading state (e.g., the detachment leading state 230 of FIG. 2) to generate a detachment leading sound (e.g., sound notification for removal) for leading to detachment of the HMD device 10 worn by the wearer 20. The detachment leading sound may be output through a speaker (e.g., the speaker 343 of FIG. 3) included in the HMD device 10. The detachment leading sound may be output through an earphone worn by the wearer 20. The detachment leading sound may be preset. The detachment leading sound may be updated.

In operation 521, the HMD device 10 may determine whether a detachment event occurs. The detachment event may occur when the HMD device 10 is detached from the wearer 20. When the detachment event occurs, the HMD device 10 may switch the state to the idle state 260 in operation 533 to output a black screen through the display 351 and block audio output.

When the detachment event does not occur, the HMD device 10 may determine whether the agent call function is activated in operation 523. The agent call function may be activated by setting information about an agent to request for help for detachment. The agent information may be information (e.g., a phone number) necessary to transfer information to lead to detachment (e.g., request removal). The HMD device 10 may have a predetermined waiting time (e.g., 10 minutes) for detecting the occurrence of the detachment event. In this case, even if the agent call function is activated, the HMD device 10 may generate a detachment leading sound, and may switch to an agent call state (e.g., the agent call state 240 of FIG. 2) after a set time, which is the predetermined waiting time, elapses.

In operation 525, the HMD device 10 may call an agent (e.g., the agent 160 of FIG. 1B). The HMD device 10 may call the agent 160 by transmitting a message. When the HMD device 10 calls the agent 160, the HMD device 10 may transmit a message for leading to detachment to an agent device (e.g., the agent device 170 of FIG. 1B). When the HMD device 10 calls the agent 160, the HMD device 10 may transfer location information about the HMD device 10 to the agent device 170. The location information may be used by the agent 160 to quickly identify the sleep onset location of the wearer 20 through the agent device 820.

In operation 527, the HMD device 10 may determine whether the agent device 170 approaches within a predetermined range. When the agent device 170 approaches, the HMD device 10 may generate a detachment leading sound (e.g., sound notification for removal) in operation 529. The generation of the detachment leading sound may serve to lead to the agent 160 to more easily approach the location of the HMD device 10.

In operation 531, the HMD device 10 may determine whether a detachment event occurs. The detachment event may occur when the HMD device 10 is detached from the wearer 20 by the agent 160. When the detachment event occurs, the HMD device 10 may switch (e.g., change) the state to the idle state 260 in operation 533 to output a black screen through the display 351 and block audio output.

In the HMD device 10, a plurality of agent devices 170 may be set or configured to lead to detachment (e.g., removal), transfer the control right of the external device, transfer the authority for managing the schedule and/or the preset alarm, or indicate that the wearer 20 has poor sleep quality. In this case, priority may be assigned to the plurality of agent devices 170. The HMD device 10 may call (e.g., send a request) the agent device 170 based on the priority. For example, when an event for calling occurs, the HMD device 10 may call an agent device having the highest priority. When the cause of the call is not resolved until a predetermined time elapses after the call, the HMD device 10 may call an agent device having a next priority.

The HMD device 10 may monitor and determine whether the time when the sleep onset of the wearer 20 is detected is included in a sleep time range (e.g., after 8 p.m.). When the time when the sleep onset of the wearer 20 is detected is not included in the sleep time range, the HMD device 10 may generate an alarm after a predetermined waiting time (e.g., 30 minutes) elapses. This is to allow a certain amount of sleep time (e.g., 30 minutes) by considering that the wearer 20 takes a nap. The predetermined waiting time for allowing a nap may be preset or changed. The allowing of a nap may be applied under the assumption that it is determined that the sleep onset posture of the wearer 20 is not the normal posture.

When it is determined that the time when the sleep onset of the wearer 20 is detected is included in the sleep time range (e.g., period) but the sleep onset posture of the wearer 20 is not the normal posture, the HMD device 10 may generate a detachment leading sound (e.g., sound notification for removal) to lead to the wearer 20 to sleep in the normal posture after detaching the HMD device 10.

According to one or more embodiments, the HMD device 10 may identify whether there is an external device (e.g., a smart home device (e.g., the air conditioner 930 or the lighting device 940 of FIG. 9)) connected to the HMD device 10 for interworking. When there is a connected external device, the HMD device 10 may hand over an authority to perform control for limiting or switching the function of the external device to the agent device 170. To that end, it is possible to perform an authentication procedure on whether the agent device 170 may have the corresponding authority. The control for suggesting or switching the function of the external device may include control of temperature and/or illuminance to help the wearer 20 sleep well.

According to one or more embodiments, the HMD device 10 may obtain the heart rate of the wearer 20. The heart rate of the wearer 20 may be measured through a heart rate sensor. The heart rate sensor may be included in the HMD device 10. The HMD device 10 may receive the heart rate of the wearer 20 from a wearable device such as a smart watch. The HMD device 10 may determine the sleep quality of the wearer 20 based on the heart rate of the wearer 20. For example, when it is detected that the heart rate of the wearer 20 is faster than or equal to a threshold level, the HMD device 10 may determine that the sleep quality of the wearer 20 is poor. In this case, the HMD device 10 may notify the agent device 170 that the wearer 20 is not sleeping comfortably.

According to one or more embodiments, the HMD device 10 may analyze whether the wearer 20 entered the sleep onset state intentionally or not. The HMD device 10 may analyze the content used before sleep onset. For example, when the content viewed before the sleep onset is sleep-inducing content, the HMD device 10 may analyze that the sleep onset of the wearer 20 is intentional. When it is determined that the sleep onset of the wearer 20 is not intended, the HMD device 10 may request another device of the wearer 20 that manages the schedule or preset alarm of the wearer 20 to transfer information about the schedule or preset alarm to the agent device 170. The HMD device 10 may transfer authentication information to be used by the agent device 170 to obtain information about the schedule or the preset alarm of the wearer 20 to the agent device 170.

FIGS. 6A to 6D are views illustrating one or more examples of predicting a sleep onset of a wearer (e.g., the wearer 20 of FIG. 1A) in an HMD device (e.g., the HMD device 10 of FIG. 1A) according to one or more embodiments of the disclosure.

Referring to FIGS. 6A to 6D, the HMD device 10 may include one or more sensor modules (e.g., IR camera modules) (e.g., the first to fourth IR cameras 321a, 321b, 321c, and 321d of FIG. 4B) disposed therein toward the face (e.g., eyes) of the wearer 20. For example, at least one first IR camera (e.g., the third or fourth IR cameras 321c and 321d of FIG. 4B) may be disposed inside the HMD device 10 to face the right eye. The at least one first IR camera 321c or 321d may be an IR camera for the right eye. For example, at least one second IR camera (e.g., the first or second IR cameras 321a and 321b of FIG. 4B) may be disposed inside the HMD device 10 to face the left eye. The at least one first IR camera 321a and 321b may be an IR camera for the left eye.

The HMD device 10 may obtain an eye image (e.g., the right-eye image 610a and/or the left-eye image 610b) of the wearer 20 based on an image captured by the at least one first IR camera 321c or 321d and/or the at least one second IR camera 321a or 321b. For example, the HMD device 10 may obtain the right-eye image 610a of the wearer 20 based on the image captured by the at least one first IR camera 321c or 321d. For example, the HMD device 10 may obtain a left-eye image 610b of the wearer 20 based on the image captured by the at least one second IR camera 321a or 321b.

The HMD device 10 may obtain a first reference point 630a (hereinafter, referred to as a “right-eye reference point”) from the right-eye image 610a. The HMD device 10 may obtain whether the right-eye reference point 630a matches a first alignment point 620a (hereinafter, referred to as a “right-eye alignment point”). The HMD device 10 may obtain a second reference point 630b (hereinafter, referred to as a “left-eye reference point”) from the left-eye image 610b. The HMD device 10 may obtain whether the left-eye reference point 630b matches a second alignment point 620b (hereinafter, referred to as a “left-eye alignment point”). The HMD device 10 may determine whether the sleep onset posture (or sleeping posture) of the wearer 20 is the normal posture based on whether the right-eye reference point 630a matches the right-eye alignment point 620a. The HMD device 10 may determine whether the sleep onset posture (or sleeping posture) of the wearer 20 is the normal posture based on whether the left-eye reference point 630b matches the left-eye alignment point 620b. The HMD device 10 may determine whether the sleep onset posture (or sleeping posture) of the wearer 20 is the normal posture based on at least one of whether the right-eye reference point 630a matches the right-eye alignment point 620a or whether the left-eye reference point 630b matches the left-eye alignment point 620b. The HMD device 10 may determine whether the sleep onset posture (or sleeping posture) of the wearer 20 is the normal posture based on whether the right-eye reference point 630a matches the right-eye alignment point 620a and whether the left-eye reference point 630b matches the left-eye alignment point 620b. In the disclosure, the posture of the wearer 20 at the time of detecting the sleep onset of the wearer 20 may be referred to as the “sleep onset posture”, and the posture of the wearer 20 in the sleep state may be referred to as the “sleeping posture”. The sleep onset posture and the sleeping posture are only divided according to the state of the wearer 20, and may have substantially similar meanings. For example, both the sleep onset posture and the sleeping posture may be considered as target postures for determining whether to detach the HMD device 10 from the wearer 20 according to the detachment leading function proposed as one or more embodiments of the disclosure. Accordingly, in describing the disclosure, it should be understood that the “sleep onset posture” and the “sleeping posture” may be used in the similar technical meanings. However, for convenience of description, the term “sleep onset posture” will be used as possible in the disclosure, but various embodiments of the disclosure may be equally applied to the “sleeping posture” as well as the “sleep onset posture”.

According to one or more embodiments, when the locations of the right-eye reference point 630a and the right-eye alignment point 620a obtained from the right-eye image 610a substantially match each other on the coordinates of the plane (2D), and the locations of the left-eye reference point 630b and the left-eye alignment point 620b obtained from the left-eye image 610b substantially match each other on the coordinates of the plane (2D), the HMD device 10 may determine that the sleep onset posture of the wearer 20 is the normal posture (see FIG. 6A).

According to one or more embodiments, when the locations of the right-eye reference point 630a and the right-eye alignment point 620a obtained from the right-eye image 610a substantially match on the coordinates of the plane (2D), and the locations of the left-eye reference point 630b and the left-eye alignment point 620b obtained from the left-eye image 610b substantially do not match on the coordinates of the plane (2D), the HMD device 10 may determine that the sleep onset posture of the wearer 20 is not the normal posture (see FIG. 6B). It may be predicted (e.g., determined) that the wearer 20 is wearing the HMD device 10 with the left portion thereof lowered.

According to one or more embodiments, when the locations of the right-eye reference point 630a and the right-eye alignment point 620a obtained from the right-eye image 610a do not substantially match on the plane (2D) coordinates, and the locations of the left-eye reference point 630b and the left-eye alignment point 620b obtained from the left-eye image 610b do not substantially match on the plane coordinates, the HMD device 10 may determine that the sleep onset posture of the wearer 20 is not the normal posture (see FIG. 6C). It may be predicted that the wearer 20 wears the HMD device 10 with both the left and right portions thereof lowered.

According to one or more embodiments, when the locations of the right-eye reference point 630a and the right-eye alignment point 620a obtained from the right-eye image 610a do not substantially match on the plane (2D) coordinates and the locations of the left-eye reference point 630b and the left-eye alignment point 620b obtained from the left-eye image 610b do not substantially match on the plane coordinates, the HMD device 10 may determine that the sleep onset posture of the wearer 20 is not the normal posture (see FIG. 6D). It may be predicted that the wearer 20 wears the HMD device 10 with both the left and right portions raised.

As described above, only when the right-eye reference point 630a and the right-eye alignment point 620a indicate substantially the same location (e.g., position), and the left-eye reference point 630b and the left-eye alignment point 620b also indicate substantially the same location, the HMD device 10 may predict that the wearer 20 enters the sleep onset in the normal location or is sleeping. The HMD device 10 may determine to indicate substantially the same location even when the right-eye reference point 630a and the right-eye alignment point 620a or the left-eye reference point 630b and the left-eye alignment point 620b do not completely overlap each other but coexist within a predetermined range (e.g., area or distance).

In the above-described example, the HMD device 10 determines whether the sleep onset posture of the wearer 20 is the normal posture based on the location (e.g., position) of the wearer 20's eyes and the location (e.g., position) of the lens (e.g., the lens 353 of FIG. 4D) or the display (e.g., the display 351 of FIG. 4D). The HMD device 10 may determine whether the sleep onset posture of the wearer 20 is the normal posture based on the direction when the eyes of the wearer 20 are viewed from a lens (e.g., the lens 353 of FIG. 4D) or a display (e.g., the display 351 of FIG. 4D). In this case, the HMD device 10 may determine that the sleep onset posture of the wearer 20 is not the normal posture by recognizing that the direction of at least one of the left eye or the right eye is turned.

The HMD device 10 may determine whether the sleep onset posture of the wearer 20 is the normal posture based on an image captured by at least one camera or a sensing signal sensed by at least one sensor (e.g., the first and/or second IR sensors 317a and 317b of FIG. 4A). The at least one camera may include at least one depth camera (e.g., the first and second depth cameras 311a and 311b of FIG. 4A). The at least one camera may include at least one side camera (e.g., the first and second side cameras 313a and 313b of FIG. 4A). The at least one camera may include the at least one depth camera 311a or 311b or the at least one side camera 313a or 313b. The at least one camera may include the at least one depth camera 311a and 311b and the at least one side camera 313a and 313b.

According to one or more examples, the HMD device 10 may recognize that the wearer 20 closes the eyes and determine whether the sleep onset posture of the wearer 20 is the normal posture based on information obtained by at least one camera (e.g., the depth cameras 311a and 311b or the side cameras 313a and 313b) or at least one sensor (e.g., the IR sensors 317a and 317b).

If the distance to the object stays within a threshold level for a predetermined time based on the information obtained by the depth cameras 311a and 311b or the IR sensors 317a and 317b, the HMD device 10 may predict that the wearer 20 has fallen asleep while lying face down. In this case, the HMD device 10 may determine that the sleep onset posture of the wearer 20 is not the normal posture.

When the distance to the object stays within the threshold level for the predetermined time based on the information obtained by the side cameras 313a and 313b, the HMD device 10 may predict that the wearer 20 lies sideways and falls asleep. However, the HMD device 10 may not determine that the sleep onset posture of the wearer 20 is not the normal posture. This is because the wearer 20 may fall asleep in the normal posture of lying sideways on the bed. The HMD device 10 may predict the sleep onset posture of the wearer 20 using other information. For example, as described with reference to FIGS. 6A to 6D, the HMD device 10 may determine whether the sleep onset posture of the wearer 20 is the normal posture considering the eye location of the wearer 20.

FIG. 7 is a view illustrating a wearable device to be used to detect a sleep onset of a wearer (e.g., the wearer 20 of FIG. 1A) in an HMD device (e.g., the HMD device 10 of FIG. 1A) according to one or more embodiments of the disclosure.

Referring to FIG. 7, a wearable device may be provided in various forms such as glasses, a ring, or a watch. The wearable device 700 may include, e.g., a smart watch 700. The smart watch 700 may be worn on the user's wrist. The smart watch 700 may include various sensors. For example, the smart watch 700 may include an electric biometric sensor 710, an optical heart rate sensor 720, an acceleration sensor, and/or a gyro sensor.

The smart watch 700 may obtain user movement and/or biometric information (e.g., heart rate, respiration, pulse rate, and electrocardiogram) based on the sensing signal sensed by at least one sensor. The smart watch 700 may determine whether the user is asleep based on the obtained information. The smart watch 700 may recognize (e.g., identify) the posture in which the user is asleep based on the obtained information. The smart watch 700 may recognize the user's movement during sleep based on the obtained information.

According to one or more embodiments, the smart watch 700 may transmit, to an HMD device (e.g., the HMD device 10 of FIG. 1A), information indicating whether the user is asleep in the normal posture or whether the user is asleep in a non-normal posture. In this case, the HMD device 10 may determine whether the user is asleep in the normal posture or whether the user is asleep in a non-normal posture, based on the information transferred by the smart watch 700.

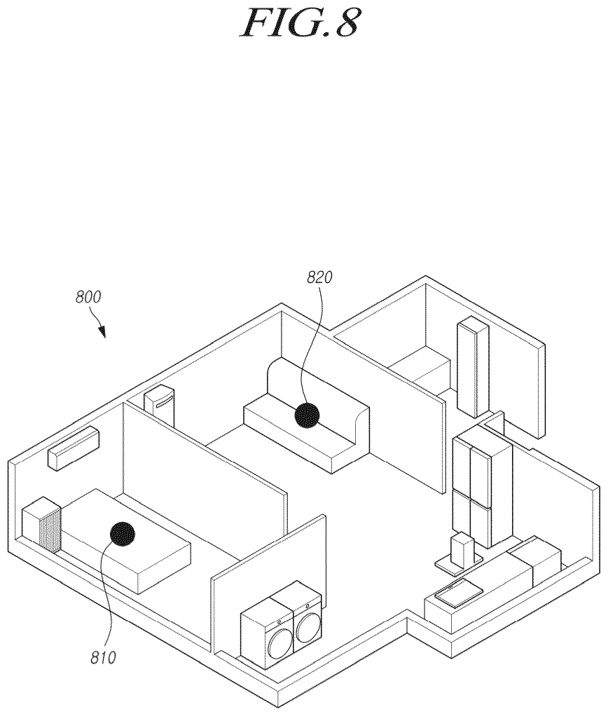

FIG. 8 is a view illustrating one or more examples of obtaining information about the location where a wearer (e.g., the wearer 20 of FIG. 1A) falls asleep in an HMD device (e.g., the HMD device 10 of FIG. 1A) according to one or more embodiments of the disclosure.

Referring to FIG. 8, when the HMD device 10 detects the sleep onset of the wearer 20, the HMD device 10 may obtain information about the current location 810 and may use the obtained location information to determine the sleep onset posture of the wearer 20. The HMD device 10 may obtain location information and/or information about a distance from another device based on UWB technology. The HMD device 10 may predict where the wearer 20 is asleep based on the location information. For example, when the location information indicates the location 810 where a bed is placed, the HMD device 10 may predict that the wearer 20 falls asleep on the bed. In this case, the sleep onset posture of the wearer 20 may be highly likely to be the normal posture.

The HMD device 10 may predict in which direction and/or in which posture the wearer 20 is sleeping considering a sensing signal sensed (e.g., detected) by at least one sensor (e.g., the downward cameras 315a and 315b of FIG. 4A or the IMU sensor 331 of FIG. 4C) in addition to the location information. This may be used to determine whether the wearer 20 falls asleep in the normal posture.

The HMD device 10 may transfer the location information to the agent device 820 (e.g., the agent device 170 of FIG. 1B) to lead to detachment by the agent (e.g., the agent 160 of FIG. 1B). This may help the agent 160 to quickly move to the sleep onset location of the wearer 20 based on the location information identified through the agent device 820.

FIG. 9 is a view illustrating one or more examples of transferring a control right of a smart home to an agent device (e.g., the agent device 170 of FIG. 1B) in an HMD detachment leading system according to one or more embodiments of the disclosure.

Referring to FIG. 9, an HMD device (e.g., the HMD device 10 of FIG. 1A) may identify whether there is an external device (e.g., a smart home device (e.g., the air conditioner 930 or the lighting device 940)) connected to the HMD device 10 or another device (e.g., a smartphone of the wearer) for interworking. The HMD device 10 may transfer the control right to control the functions of the external devices 930 and 940 connected for interworking to the agent device 920. The control right may include a right to control temperature and/or illuminance (e.g., lighting) to help the wearer 910 sleep well. To that end, the HMD device 10 and/or the external devices 930 and 940 may perform an authentication procedure with the device that controls the smart home.

When receiving the control right from the HMD device 10, the agent device 170 may control the operation of an external device (e.g., a smart home device (e.g., the air conditioner 930 or the lighting device 940)) through a predetermined application program.

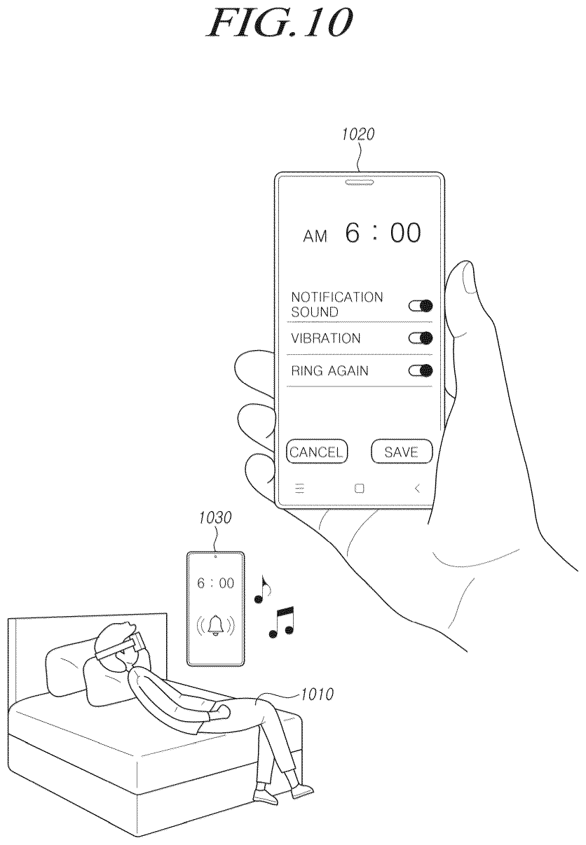

FIG. 10 is a view illustrating one or more examples of transferring schedule management including a schedule or an preset alarm of a wearer (e.g., the wearer 20 of FIG. 1A) to an agent device (e.g., the agent device 170 of FIG. 1B) in an HMD detachment leading system according to one or more embodiments of the disclosure.

Referring to FIG. 10, the HMD device 10 may analyze whether the sleep onset of the wearer 1010 is intentional or not. The HMD device 10 may analyze the content used before sleep onset. For example, when the content viewed before the sleep onset is sleep leading content, the HMD device 10 may analyze that the sleep onset of the wearer 1010 is intentional. When it is determined that the sleep onset of the wearer 1010 is not intended, the HMD device 10 may request another device (e.g., a smart phone) of the wearer 1010 that manages the schedule or preset alarm of the wearer 1010 to transfer information about the schedule or preset alarm to the agent device 1020. The HMD device 10 may transfer authentication information to be used by the agent device 1020 to obtain information about the schedule or the preset alarm of the wearer 1010 to the agent device 1020. In this case, the agent (e.g., the agent 160 of FIG. 1B) may check the schedule and/or preset alarm of the wearer 1010 using the agent device 170.

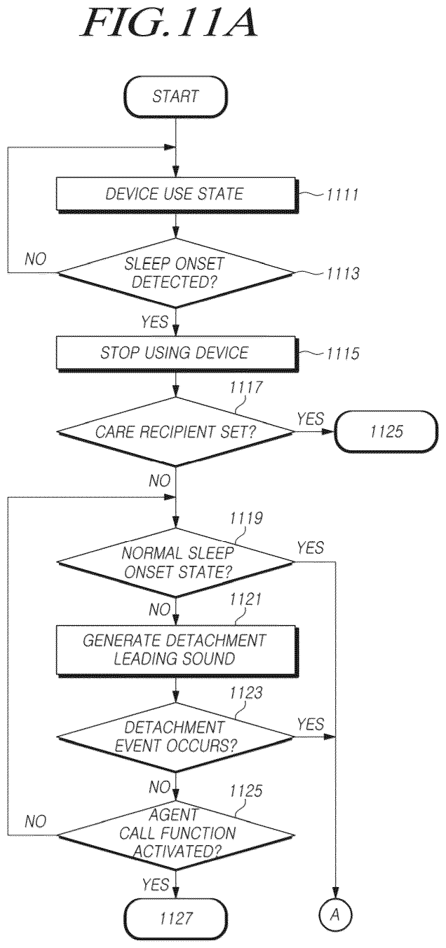

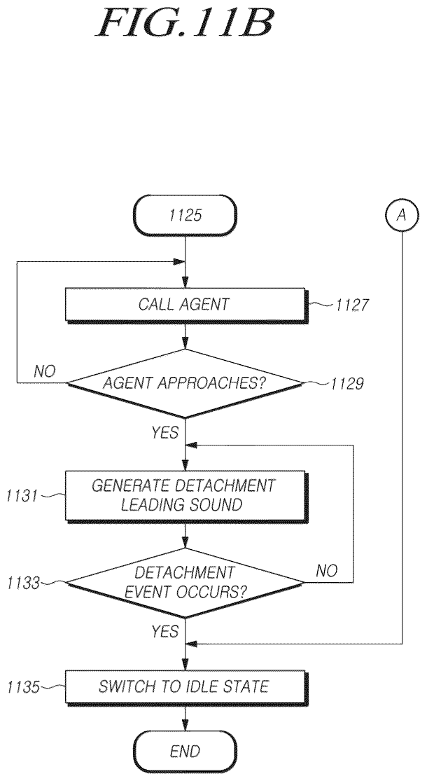

FIG. 11A or 11B is a control flowchart illustrating leading to detachment in an HMD device (e.g., the HMD device 10 of FIG. 1A) according to one or more embodiments of the disclosure.

The control flowchart of FIG. 11A or 11B adds the operation (operation 1117) of requesting an agent device (e.g., the agent device 170 of FIG. 1B) to detach the HMD device 10 in response to detecting the sleep onset without generating (e.g., providing) a detachment leading sound (e.g., sound notification for removal) on its own upon sleep onset when a wearer (e.g., the wearer 20 of FIG. 1A) to the operations of the control flows of FIGS. 5A and 5B. Other operations (operations 1111 to 1115 and operations 1119 to 1135) may correspond one-to-one to operations 511 to 533 according to the control flows in FIGS. 5A and 5B.

Referring to FIG. 11A or 11B, when the HMD device 10 detects a sleep onset in a use state, the HMD device 10 may stop using the device in operations 1111 to 1115. In operation 1117, the HMD device 10 may determine whether the wearer 20 is set (e.g., registered) as a care recipient. The care recipient may be, e.g., a person in need, such as a child, a patient, or an elderly person. Whether the wearer is a care recipient may be preset in the HMD device 10.

When the wearer 20 is set as a care recipient, in operation 1127, the HMD device 10 may transmit a message for calling an agent (e.g., the agent 160 of FIG. 1B) to the agent device 170 in order to request detachment of the HMD device 10. The HMD device 10 may transfer its location information to the agent device 1230. When the wearer 1210 is set as the care recipient, the HMD device 10 may request the agent device 1230 to detach the HMD device 10 regardless of the sleep onset posture without generating a self-alarm.

When the heart rate of the wearer 20 is not in a normal state, the HMD device 10 may transmit a message for calling the agent 160 to the agent device 170. To that end, the HMD device may obtain the heart rate of the wearer 20. The heart rate of the wearer 20 may be measured through a heart rate sensor. The heart rate sensor may be included in the HMD device 10. The HMD device 10 may receive the heart rate of the wearer 20 from a wearable device such as a smart watch. The HMD device 10 may determine the sleep quality of the wearer 20 based on the heart rate of the wearer 20. For example, when it is detected that the heart rate of the wearer 20 is faster than or equal to a threshold level, the HMD device 10 may determine that the sleep quality of the wearer 20 is poor. In this case, the HMD device 10 may notify the agent device 170 that the wearer 20 is not sleeping comfortably.

A plurality of agent devices 170 to be called may be set in the HMD device 10. In this case, priority may be assigned to the plurality of agent devices 170. The HMD device 10 may call the agent device 170 based on the priority. For example, when the wearer 20 is set as a care recipient, the HMD device 10 may call an agent device having the highest priority. In operation 1129, when the called agent does not approach (e.g., respond) until a predetermined time elapses after the call, the HMD device 10 may call an agent device having a next priority.

In operations 1129 to 1135, the HMD device 10 may detect that the agent device 170 approaches and may generate a detachment leading sound, and may switch to the idle state when the HMD device 10 is detached by the agent 160.

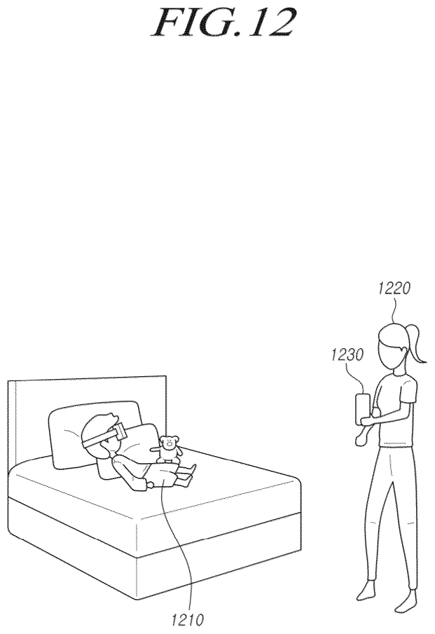

FIG. 12 is a view illustrating one or more examples of leading to detachment in an HMD detachment leading system according to one or more embodiments of the disclosure.

Referring to FIG. 12, an HMD device (e.g., the HMD device 10 of FIG. 1A) may determine whether a wearer 1210 (e.g., the wearer 20 of FIG. 1A) is set as a care recipient. The care recipient may be, e.g., a person in need, such as a child, a patient, or an elderly person. Whether the wearer is a care recipient may be preset in the HMD device 10.

When the wearer 1210 is set as a care recipient, the HMD device 10 may request the agent device 1230 (e.g., the agent device 170 of FIG. 1B) to detach the HMD device 10. The HMD device 10 may transfer its location information to the agent device 1230. When the wearer 1210 is set as the care recipient, the HMD device 10 may request the agent device 1230 to detach the HMD device 10 regardless of the sleep onset posture without generating a self-alarm. The agent 1220 may recognize that the wearer 1210 is asleep through the agent device 1230. The agent 1220 may identify the location of the wearer 1210 based on the location information output through the agent device 1230. The agent 1220 may quickly move to the place where the wearer 1210 is asleep to detach the HMD device 10 worn by the wearer 1210.

The terms as used herein are provided merely to describe some embodiments thereof, but are not intended to limit the disclosure. As used herein, the singular forms “a,” “an,” and “the” are intended to include the plural forms as well, unless the context clearly indicates otherwise. As used herein, each of such phrases as “A or B,” “at least one of A and B,” “at least one of A or B,” “A, B, or C,” “at least one of A, B, and C,” and “at least one of A, B, or C,” may include all possible combinations of the items enumerated together in a corresponding one of the phrases. As used herein, the term ‘and/or’ should be understood as encompassing any and all possible combinations by one or more of the enumerated items. As used herein, the terms “include,” “have,” and “comprise” are used merely to designate the presence of the feature, component, part, or a combination thereof described herein, but use of the term does not exclude the likelihood of presence or adding one or more other features, components, parts, or combinations thereof. As used herein, the terms “first” and “second” may modify various components regardless of importance and/or order and are used to distinguish a component from another without limiting the components.

As used herein, the terms “configured to” may be interchangeably used with the terms “suitable for,” “having the capacity to,” “designed to,” “adapted to,” “made to,” or “capable of” depending on circumstances. The term “configured to” does not essentially mean “specifically designed in hardware to.” Rather, the term “configured to” may mean that a device can perform an operation together with another device or parts. For example, a ‘device configured (or set) to perform A, B, and C’ may be a dedicated device to perform the corresponding operation or may mean a general-purpose device capable of various operations including the corresponding operation.

Meanwhile, the terms “upper side”, “lower side”, and “front and rear directions” used in the disclosure are defined with respect to the drawings, and the shape and position of each component are not limited by these terms.

In the disclosure, the above-described description has been made mainly of specific embodiments, but the disclosure is not limited to such specific embodiments, but should rather be appreciated as covering all various modifications, equivalents, and/or substitutes of various embodiments.

What is claimed is:

1. A method of requesting detachment of a head-mounted display (HMD) device, comprising:
detecting a sleep onset of a wearer wearing the HMD device;
based on the sleep onset of the wearer being detected and the wearer not being set as a care recipient, providing an alarm for the detachment of the HMD device; and
based on the sleep onset of the wearer being detected and the wearer being set as the care recipient, sending a request to detach the HMD device to an agent device.

2. The method of claim 1, further comprising:
detecting the sleep onset of the wearer to predict a sleep onset posture of the wearer;
based on the sleep onset posture not being in a normal posture for the sleep onset, providing the alarm for the detachment of the HMD device; and
based on the sleep onset posture being in the normal posture for the sleep onset, outputting a black screen through a display of the HMD device.

3. The method of claim 1, further comprising:
detecting the sleep onset of the wearer to predict a sleep onset posture of the wearer; and
based on the sleep onset posture being in a normal posture for the sleep onset, controlling an external device to restrict or switch a function of the external device.

4. The method of claim 1, further comprising:
detecting the sleep onset of the wearer in a sleep time period to predict a sleep onset posture of the wearer; and
based on the sleep onset posture not being in a normal posture for the sleep onset, providing the alarm for the detachment of the HMD device.

5. The method of claim 1, further comprising:
based on the HMD device not being detached in response to the alarm, requesting the agent device to detach the HMD device.

6. The method of claim 1, further comprising:
providing the alarm based on the agent device approaching within a predetermined distance.

7. The method of claim 1, wherein sending the request to detach the HMD device comprises transferring location information about the HMD device to the agent device.

8. The method of claim 1, wherein sending the request to detach the HMD device comprises transferring, to the agent device, authentication information to be used to obtain information about a schedule or a preset alarm of the wearer from a device managing the schedule or the preset alarm.

9. A head-mounted display (HMD) device, comprising:
at least one sensor;
a display;
a communication interface configured communicate with another device;
at least one processor comprising processing circuitry and operably connected to the at least one sensor, the display, or the communication interface; and
memory comprising one or more storage media storing instructions individually or collectively executable by the at least one processor, wherein as the instructions are executed by the at least one processor, the HMD device is operated to:
based on a sensing signal of the at least one sensor, detect a sleep onset of a wearer wearing the HMD device;
based on the wearer not being set as a care recipient, provide an alarm for detachment of the HMD device; and
based on the wearer being set as the care recipient, control the communication interface to send a request to detach the HMD device to an agent device.

10. The HMD device of claim 9, wherein as the instructions are executed by the at least one processor, the HMD device is operated to:
based on the sensing signal of the at least one sensor, detect the sleep onset of the wearer to predict a sleep onset posture of the wearer;
based on the sleep onset posture not being in a normal posture for the sleep onset, provide the alarm for the detachment of the HMD device; and
based on the sleep onset posture being in the normal posture for the sleep onset, output a black screen through the display.

11. The HMD device of claim 9, wherein as the instructions are executed by the at least one processor, the HMD device is operated to:
based on the sensing signal of the at least one sensor, detect the sleep onset of the wearer to predict a sleep onset posture of the wearer; and
based on the sleep onset posture being in a normal posture for the sleep onset, control, through the communication interface, an external device to restrict or switch a function of the external device.

12. The HMD device of claim 9, wherein as the instructions are executed by the at least one processor, the HMD device is operated to:
based on detecting the sleep onset of the wearer in a sleep time range, predict a sleep onset posture of the wearer based on the sensing signal of the at least one sensor;
based on the sleep onset posture not being in a normal posture for the sleep onset, provide the alarm for the detachment of the HMD device.

13. The HMD device of claim 9, wherein as the instructions are executed by the at least one processor, the HMD device is operated to:
based on the HMD device not being detached in response to the alarm, control the communication interface to send a request to detach the HMD device to the agent device.

14. The HMD device of claim 9, wherein as the instructions are executed by the at least one processor, the HMD device is operated to:
based on the sensing signal of the at least one sensor, provide the alarm by recognizing that the agent device approaches within a predetermined distance.

15. The HMD device of claim 9, wherein as the instructions are executed by the at least one processor, the HMD device is operated to:
transfer location information about the HMD device to the agent device through the communication interface or transfer authentication information to be used to obtain information about a schedule or a preset alarm of the wearer, from a device managing the schedule or the preset alarm, to the agent device through the communication interface.

16. A head-mounted display (HMD) device, comprising:
a display;
a communication interface;
memory storing instructions;
at least one processor operatively connected to the memory, the display, and the communication interface, the at least one processor being configured to execute the instructions to:
detect a sleep onset of a wearer wearing the HMD device;
determine that the wearer is set as a care recipient or is not set as the care recipient, based on information stored in the memory;
based on the wearer not being set as the care recipient and the sleep onset being detected, provide an alarm alerting the wearer to detach the HMD device; and
based on the wearer being set as the care recipient and the sleep onset being detected, control the communication interface to send a request to detach the HMD device to an agent device not operated by the wearer.

17. The HMD device of claim 16, wherein the at least one processor is further configured to execute the instructions to:
determine whether a posture of the wearer is a normal sleep onset posture; and
based on the posture being the normal sleep onset posture, deactivate a smart device in a vicinity of the wearer.

18. The HMD device of claim 16, wherein the at least one processor is further configured to execute the instructions to:
determine whether a posture of the wearer is a normal sleep onset posture;
based on the posture not being the normal sleep onset posture, provide the alarm for the detachment of the HMD device; and
based on the posture being the normal sleep onset posture, output a black screen through the display.

19. The HMD device of claim 16, wherein the at least one processor is further configured to execute the instructions to:
based on the HMD device not being detached based on the alarm, control the communication interface to send a request to detach the HMD device to the agent device.

20. The HMD device of claim 16, wherein the at least one processor is further configured to execute the instructions to:
transfer location information about the HMD device to the agent device through the communication interface.
